(19) United States
(12) Patent Application Publication
(10) Pub. No.: US 2009/0286007 A1
(43) Pub. Date: Nov. 19, 2009

(54) METHODS AND APPARATUS FOR FORMING A PART AT A LOCATION ON A WORKPIECE

(75) Inventor: Carl David Monnington Brancher, Abergavenny (GB)

Correspondence Address: VOLENTINE & WHITT PLLC, ONE FREEDOM SQUARE, 11951 FREEDOM DRIVE SUITE 1260, RESTON, VA, 20190, US

(73) Assignee: MATERIALS SOLUTIONS, Birmingham (GB)

(21) Appl. No.: 12/271,317

(22) Filed: Nov. 14, 2008

(30) Foreign Application Priority Data
Nov. 15, 2007 (GB) 07224297.8

(51) Int. Cl. B05D 3/06; B05C 11/00

(52) U.S. Cl. 427/554; 118/620

(57) ABSTRACT

This invention relates to methods and apparatus performing a part at a location on the workpiece. In particular the object is to form a bund to contain a powder around a forming part. In different aspects the retained powder may not be heated above half its melting point and/or the powder dispensing systems may include a delivery hopper which can be translated across a flat area and carries the recoater blade on the hopper.

### BACKGROUND

In the field of sintering or melting powders to form solid objects by the selective application of energy typically from a laser beam the various different technologies may be characterised as either ‘powder bed’ and ‘blow powder’.

In the case of a powder bed machine, for example a commercially available EOS M270 from EOS GmbH Electro Optical Systems, the solid object is formed by the selective application of a laser into successive layers of powder spread from a feed hopper in a tank by a recoater blade. The laser beam is directed by a galvanometer.

By contrast, in a blown powder system (for example a Trumpf DMD 505) powder is ejected adjacent the laser beam at a ‘nozzle’ and this physical nozzle requires a physical scanning (with respect to the object to be built/repaired). Moving either the nozzle (with powder feed lines and laser fibre) or the object (as in the case of Trumpf) is non trivial and requires high speed precision.

This distinction is important when considering the applications of these broadly similar technologies.

In the case of a powder bed system extremely accurate parts may be built, however it is limited to building objects that can be contained within the tank of powder.

The accuracy is achieved by the support of the powder bed and the separation of powder application from powder distribution. The (mass-less) laser beam can be easily scanned by a galvanometer. The powder is spread by a ‘recoater’ blade pushing a ‘pile’ of powder from a source ‘heap’. The gap between the blade and the top of the part-built object defines the build layer and therefore no precision is required to the ejection of powder from the source hopper.

In the case of the blown powder system no such size limitation exists however the accuracy of build is not as good. This is principally because the powder distribution is physically tied to the laser application. A powder dispensing nozzle surrounds the exit of the laser beam and as this is a physical object (unlike a laser beam that can be directed by mirrors) it has to be physically moved with respect to the build area to selectively apply the laser (and powder).

Further, powder ejection has to be precisely controlled, which is presently unachievable sufficient to build parts accurately. Additionally the object is not supported by a bed of powder during build thereby limiting the designs of objects that can be built.

There is a further, non obvious, limitation to the blown powder system. It is extremely difficult to generate the necessary software and hardware controls to visit each place that needs building only once and/or turn on and off the laser and powder ejection and as such this has not been achieved to date. As a result, parts built generally appear castellated where laser path trajectory crosses because these points received a double application of powder.

By contrast the scanning of a laser beam by a galvanometer is much more precise and easy to achieve. And the powder exists as a layer upon the part in a powder bed system, so a second ‘visit’ of the laser beam does not increase the build height, it merely re-melts the material.

### SUMMARY

From one aspect the invention consists in a method of forming a part at a location on a workpiece including: forming a flat surface at the location if one is not already present; orientating the flat surface in a horizontal upwardly facing alignment; and forming the part using a powder dispersing system to form successive layers of the part, wherein during the forming stage a laser selectively fuses portions of the powder in a layer to create an element of the part and an element of a bund enabling the forming bund to retain powder around the part and thus allow the succeeding layer to be supported.

The powder dispensing system may include a recoater or levelling blade which can be translated across the flat surface and orthogonal thereto and a delivery hopper that may be moved orthogonal to the surface and may also be translated across the surface with the recoater blade.

A galvanomer delivering the laser beam may also be carried with the delivery hopper orthogonal to the surface (thereby retaining a fixed focus distance to the build plane).

The powder is preferably a metal alloy such as a steel and in particular a high temperature metal alloy such as Cobalt Chrome or a Nickel or Nickel Iron alloy or a refractory metal alloy such as Titanium. These may be differentiated from polymer powder bed systems that operate by heating the bed of polymer powder to just below its melting point and using a relatively low powdered laser to locally achieve sintering or melting.

From another aspect the invention includes apparatus for forming a part on the flat location of a workpiece including: a support for retaining the workpiece in an orientation with the flat surface horizontal and upwardly facing; a powder delivery head for delivering a layer of powder to the flat surface and having a levelling blade for levelling the deposited powder and a laser for fusing selection portions of a layer; and a mount for supporting the levelling blade for transverse and vertical movement relative to the surface.

The apparatus may include a motor for driving the head for at least one of transverse or vertical movement.

Whilst it is necessary that the recoater or levelling blade traverses the surface and moves orthogonally with respect to it, and preferable that the galvanometer head moves orthogonally (to maintain a fixed focal length) the delivery hopper may traverse or may be static, releasing a quantity of powder ahead of the recoater blade that traverses and thereby distributing the powder across the powder bed.

There are applications where it is useful to attach e.g. a flange or boss to a large object such as a forged tube. It would be useful if such a small precision part could be built directly onto the large part—including parts too big to fit into a reasonable sized powder bed tank (having regard for the cost of the inventory of powder and other commercial constraints).

The problem to solve is therefore this; how to adapt the powder bed technology such that it can be applied to build upon or repair larger parts that are not contained within a powder bed.

Although the invention has been defined above it is to be understood it includes any inventive combination of the features set out above in the following description.

### BRIEF DESCRIPTION OF THE DRAWINGS

The invention may be performed in various ways and specific embodiments will now be described with reference to the accompanying drawings, in which:

FIG. 1 is a schematic view of apparatus for forming a part on a workpiece; and

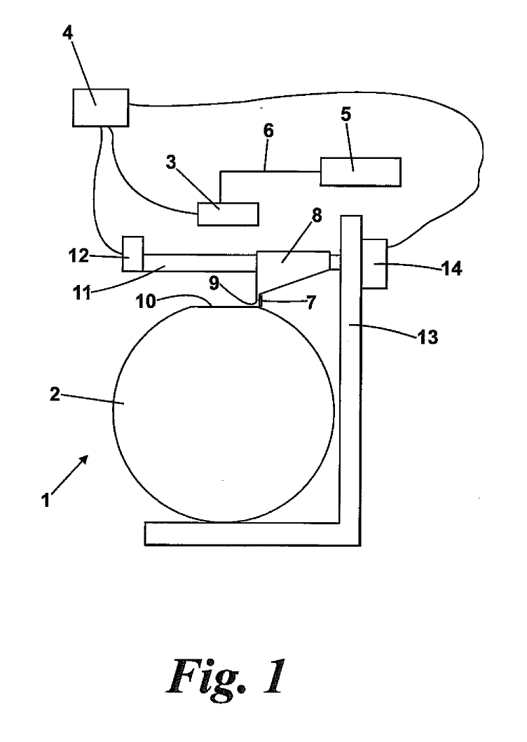

FIG. 2 is an enlarged scrap cross-section showing a part being built.

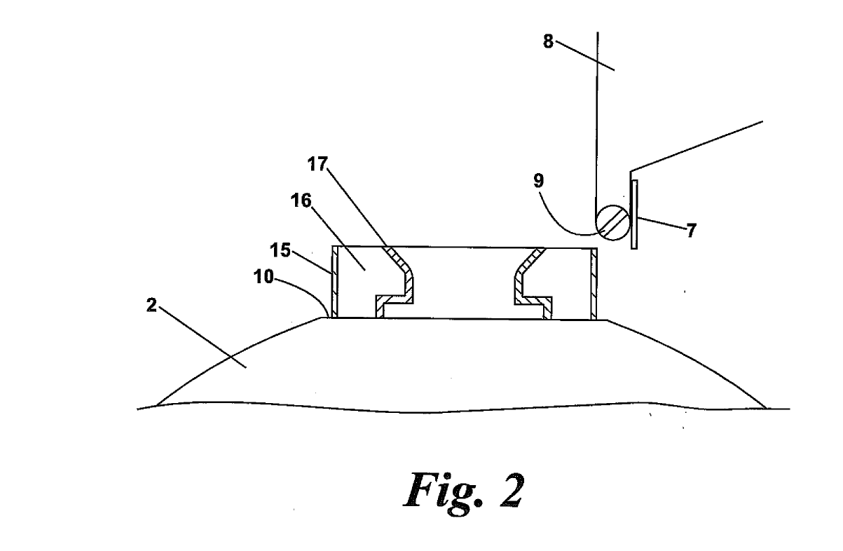

### DETAILED DESCRIPTION OF EMBODIMENTS

In a machine generally indicated at 1 there is a workpiece 2 (such as for a turbine engine casing) consisting of a large (e.g. 1 metre dia.) cylindrical surface that needs a boss added.

A galvanometer head 3 controlled by a computer or computers operating software generally indicated at 4 and fed by a laser 5 via a fibre optic cable 6.

A recoater blade 7 with a powder hopper mechanism 8 located above the top of the workpiece 2 is mounted such that it can be driven laterally with respect to the upper surface of the workpiece e.g. along a slideway 11 by a motor 12 under the control of a computer 4. The workpiece and recoater blade are stepped away from each other e.g. by 20-200 microns at a time e.g along another slideway 13 via a mechanism 14 also controlled by a computer 4.

The galvanometer head 3 may also be stepped away thereby maintaining a fixed focal length for the laser beam, for example by being mounted for movement with the hopper mechanism.

The hopper mechanism 8 may have a distributing slit or array of holes 9 controlled by a valve that allows powder to be ejected from the hopper ahead of the recoater blade. The important point to note is that this powder ejection does not need to be precise as to location or timing as it is the recoater blade that distributes it across the surface to a depth defined by the clearance between the blade and the surface. Indeed the hopper mechanism 8 may be static or moving only orthogonally with respect to the upper surface and holes 9 deliver the powder as a ‘dump’ ahead of the recoater blade that then traverses the powder bed 16 distributing the powder as a layer.

It is advantageous if the recoater blade is capable of grinding off rough material e.g. ‘weld splatter’ and e.g. is made of ceramic and rigidly mounted on a slideway.

In treating the 3D CAD files for use by the machine in addition to the usual manipulations well know to those skilled in the art, an additional feature is added—a ‘bund’ or outer wall 15 surrounding the location of the part to be built. This bund is large enough to contain the area of the part to be built 17 and sufficient to retain a bed of powder 16. This bund is built layer by layer as the part is built and can consist of whatever shape or thickness is most desirable to achieve the purpose.

Whereas the blown powder system can address curved and non horizontal surfaces the powder bed approach can only address essentially flat horizontal surfaces.

In one embodiment, the inventive method of creating the boss is therefore to: (a) create a flat area 10 on the workpiece as required (if necessary) e.g. by grinding; (b) locate and rigidly mount the workpiece with respect to the laser beam from the galvanometer head 3 and the recoater blade 7; (c) operate the machine broadly as a powder bed machine as is well known, excepting that a powder bed is created and retained by the bund built at the same time as the boss.

It can similarly be seen that instead of preparing a flat area upon which to build a new part a defective area could be ground away and rebuilt using this invention.

What is claimed is:

1. A method of forming a part at a location on a workpiece, comprising:
forming a flat surface at the location if one is not already present;
orientating the flat surface in a horizontal upwardly facing alignment; and
forming the part using a powder dispersing system to form successive layers of the part, wherein during the forming stage a laser selectively fuses portions of the powder in a layer to create an element of the part and an element of a bund enabling the forming part to retain powder around the part and thus allow the succeeding layer to be supported, wherein the powder bed is not heated above half the melting point of the powder prior to the application of the laser.

2. The method as is claimed in claim 1 wherein the powder is a metal alloy.

3. A method of forming a part at a location on a workpiece, comprising:
forming a flat surface at the location if one is not already present;
orientating the flat surface in a horizontal upwardly facing alignment; and
forming the part using a powder dispersing system to form successive layers of the part, wherein during the forming stage a laser selectively fuses portions of the powder in a layer to create an element of the part and an element of a bund enabling the forming part to retain powder around the part and thus allow the succeeding layer to be supported wherein the powder dispensing systems includes a delivery hopper which can be translated across the flat area and orthogonally thereto and a recoater blade carried on the hopper.

4. Apparatus for forming a part on a flat location of a freestanding workpiece, comprising:
a support for retaining the workpiece in an orientation with the flat surface horizontal and upwardly facing;
a powder delivery head for delivering a layer of powder to the flat surface and having a recoater blade for distributing and levelling the deposited powder by means of a traverse of the flat surface and a laser for fusing selection portions of a layer; and
a mount for supporting the head for transverse and vertical movement relative to the surface.

5. Apparatus as claimed in claim 4, further including a motor for driving the head for at least one of transverse or vertical movement.

6. Apparatus as claimed in claim 4, further including a rigidly mounted recoater blade that in addition to distributing powder also grinds off rough material.

7. Apparatus as claimed in claim 6, where the recoater blade is made of a ceramic material.
